(19) United States
(12) Patent Application Publication
(10) Pub. No.: US 2025/0151745 A1
(43) Pub. Date: May 15, 2025

(54) PALM FAT COMPOSITIONS AS SOFT AND SPREADABLE MARGARINES

(71) Applicant: ALIANZA TEAM INTERNATIONAL S.A., Bogota (CO)

(72) Inventors: Efrain Hisnardo Rojas Uribe, Bogota (CO); Henry Rivero Garcia, Bogota (CO)

(21) Appl. No.: 18/837,484

(22) PCT Filed: Aug. 25, 2022
(86) PCT No.: PCT/IB2022/057984

§ 371 Date: Aug. 9, 2024

Related U.S. Application Data
(60) Provisional application No. 63/309,197, filed on Feb. 11, 2022.

(51) Int. Cl. A23D 7/00

(52) U.S. Cl. CPC A23D 7/001

(57) ABSTRACT

The present invention relates to a fat composition for use as a soft tub margarine or spread having a fat phase and an aqueous phase, wherein the fat phase comprises a fat component of palm oil and/or fractions thereof and a post-crystallization control component of sorbitan esters. Moreover, the present invention relates to the process of obtaining said fat composition.

### TECHNICAL FIELD OF THE INVENTION

The present invention relates to fat compositions useful as margarines or spreads made of vegetable fats, mainly triglycerides obtained exclusively from palm and/or its varieties and/or fractions, wherein said fats are not submitted to modification processes such as hydrogenation or interesterification. The obtained fat compositions exhibit the required functionality, shine, creaminess, without lumps, excellent consistency, spreadability and without structural defects commonly associated to fat compositions made exclusively of palm oils.

### TECHNICAL BACKGROUND

Margarines and spreads are fat compositions made of vegetable origin widely used for cooking as an alternative to butter, which is made of animal fats. These fat compositions are water-in-oil type emulsions consisting of an aqueous phase dispersed in fine droplets in oil, which are stabilized on a network of fat crystals.

The difference between margarines and spreads lies in the fat content, wherein margarines must contain at least 80% of fat, while spreads exhibit about 30% to 70% of fat content of the total composition.

Fat compositions usually employ a mixture of liquid oils with hard fats to obtain desirable functional and sensory characteristics in margarines and/or spreads, including their resemblance to butter or specific desired functionalities. Vegetable oils and hard fats can be from different sources, for example, soybean, sunflower, palm, corn, olive, among others.

These fat compositions are desirable since they usually comprise lower levels of trans fats and saturated fats that may result unhealthy in comparison with animal butters. Likewise, the production of some vegetable fats is more sustainable, thus impacting in the profits of fat production.

For example, document WO1995007619A1 reveals fat compositions suitable as healthy margarines or spreads wherein the sunflower oil; olive oil; soybean oil; corn oil; and palm oil stearin are used.

Likewise, WO2013116593A1 teaches spread compositions having reduced levels of saturated and trans fats, comprising water, a base oil, a seed ester and a cellulose fiber, wherein the base oil used herein comprises triglycerides, fatty acids and fatty acid derivatives of natural or synthetic origin, including, but not limited to high oleic canola, soybean, palm, corn, sunflower, coconut oil, rapeseed, peanut, safflower, high oleic safflower oil, olive, cottonseed, or a mixture thereof.

Also, document WO1992015200A1 exhibits the use of hydrogenated oils for producing margarine and solid fat products, including hydrogenated canola oil, hydrogenated cottonseed oil, hydrogenated soybean oil, hydrogenated sunflower, hydrogenated corn, hydrogenated fish oil, and mixtures thereof, and a liquid edible oil selected from the group consisting of corn oil, canola oil, soybean oil, sunflower oil, peanut, safflower oil, and sesame oil and mixtures thereof.

Within the vegetable fats used for producing fat compositions, palm oil is one of the easiest raw material to be produced. Document U.S. Pat. No. 9,144,245B2 discloses a composition containing palm mid-fraction hardstock fat combined with an unsaturated vegetable oil such as olive oil, high oleic sunflower oil, canola oil, soybean oil, corn oil, peanut oil, sunflower oil, safflower oil, cottonseed oil, and combinations thereof, useful in reducing plasma cholesterol.

Likewise, document U.S. Pat. No. 7,947,323B2 relates to fat compositions for confectionery or baking application, wherein palm oil or fractions thereof with a glyceride composition with a S₂U content between 47 and 75 wt. %, a SU₂+U₃ content <40 wt. %, a S₃ content between 1 and 15 wt. %, and a diglyceride content of 3 to 12 wt. %, wherein said composition has low content of trans and saturated fatty acids.

Notwithstanding, for producing margarines and spreads, high amounts of palm oils are avoided because of its high content of triglycerides POP and PPP, which may negatively affect the spreadability and creaminess of the final product caused by the formation of lumps or granules after the fat composition being crystalized.

Also, in the state of art, chemical and/or enzymatic methods, such as interesterification, hydrogenation, mixing of various oils, and oil fractionation, are commonly used for making irreversible changes in the oils, in order to design the fats for changing their physicochemical properties and adjusting them to be viable in the desired application.

For example, document WO2008066333A1 employs enzymatic interesterification reaction in a mix of one or more oils selected from the group consisting of palm oil, soybean oil and completely hydrogenated oil, for producing margarine oil with a desired solid profile and less than 1% of trans fatty acids, wherein the obtained fat is eco-friendly and with a lower palmitic acid content than natural palm oil.

In addition, document USRE30086E teaches a randomization process for producing margarine and low-fat emulsion food spreads from palm oil, wherein palm oil is randomized or co-randomized with small amounts of other edible oils or fats, thus avoiding the use of other expensive vegetable oils, such as sunflower oil.

Other ways to obtain fat compositions is by using additives capable of intervening in the crystallization process of the water-in-oil emulsions required for obtaining margarines and spreads with the desired physicochemical properties.

For example, document EP0078568 refers to a structural fat produced from palm oil fractioning suitable for use in margarine oils, margarines, and other water-in-oil emulsified spreads capable of imparting satisfactory spreadability and heat stability, specially to stick-type products. Said structural fat has from 3 to 9% by weight SSS triglycerides; from 32 to 58% by weight SOS triglycerides; from 6 to 12% by weight SSO triglycerides; and from 20 to 32% by weight SOO/SLS triglycerides, wherein S are saturated C16-18 fatty acids, O is oleic acid and L is linoleic acid. Said structural fat is combined with one or more soft oils derived from animal, vegetable, or marine sources, including cottonseed oil, soybean oil, sunflower oil, corn oil, peanut oil, safflower oil, and the like.

Likewise, document U.S. Pat. No. 8,440,250B2 provides a crystallization accelerator capable of accelerating fat crystallization during a production step of margarine, shortening, chocolate, hard butter to be used in confectionery and bakery or the like, wherein said crystallization accelerator is sorbitan fatty acid ester having an esterification ratio of from 28 to 60% and a sorbitol-type content of from 20 to 40%, and the fatty acids used in the esterification process are palmitic acid and/or stearic acid. Said crystallization accelerator is used on fat compositions comprising plant fats such as palm oil, cocoa butter, palm oil, and palm kernel oil, among others.

Furthermore, document WO2001080659 teaches the use of sorbitan triestearate as emulsifying agent for forming a water-in-oil emulsion in the preparation of a high liquid oil margarine with less than 0.1% trans fatty acids.

Moreover, document EP2671455 provides a palm-based fractionated oil and fat with a tripalmitin content of 70-90% and 1-8% of unsaturated fatty acid content, which is obtained from the performance of a crystallization operation of palm super stearin.

Also, document WO2010060712 discloses a fat containing emulsion with specific organoleptic properties comprising 20-85% of a fat phase comprising palm oil and an emulsifier, wherein the fat comprises HHH, HOH, and HOO triacyl glycerides, and wherein H is palmitic or stearic acid and O is oleic acid. In this composition, the ratio of HHH/HOH is from 0.05 to 0.27, the ratio HOO/HHH is from 3 to 8, the palmitic acid level in the H fractions is at least 60%; and the emulsifier comprises sorbitan ester of fatty acid wherein at least 40% of the sorbitan ester of fatty acid is a sorbitan mono ester of fatty acid.

However, the excessive processing of the raw materials for producing fat compositions with specific physicochemical properties may negatively impact the production costs and the final product yield. Particularly, for fat compositions mainly based on palm oils and/or fractions thereof, it is relevant to evaluate the most suitable strategies for obtaining the desired properties, related to functionality, brightness, creaminess, granularity, spreadability, etc.

In view of all above, there is a need for producing fat compositions usable as margarines or spreads wherein only palm oils and/or fractions thereof are employed as fat source of the composition and the post-crystallization issues are attended without using modification processes, such as interesterification or hydrogenation, that increases the manufacturing costs.

### GENERAL DESCRIPTION OF THE INVENTION

The present invention relates to a fat composition with specific characteristics so that it can be used as soft tub margarines or spreads, wherein the composition exhibits a creaminess and softness desirable for said products, has a penetration value lower than 300 g/cm² at 20° C. during its shelf life, and its triglyceride content is mainly from palm oil and/or varieties and/or fractions thereof.

Particularly, the obtaining process of the composition of the present invention avoids modification techniques such as hydrogenation or interesterification, that negatively impacts the manufacturing costs of the product.

Likewise, the use of palm kernel oil, cocoa butter, canola oil, soybean oil, sunflower oil, coconut oil, or any other fat source with higher costs than palm oils, are avoided for manufacturing the composition.

Instead of the above, the present invention proposes the use of a “post-crystallization control” or “post-crystallization” component which prevents the formation or lumps or granular crystals after the crystallization of the fat composition of the invention. Said “post-crystallization control” component comprises a synergic mixture between sorbitan fatty acid esters and glycerol partial esters at a ratio of 1:0.5 to 1:10, which slows down the crystallization process of the fat composition, thus avoiding the formation of granular crystals usually formed in fat compositions exclusively made of palm oils and/or variants and/or fractions thereof, thus achieving the desired softness and creaminess in margarine and spread like products.

Therefore, the present invention provides fat composition useful as soft tub margarines or spreads and an obtaining process thereof, wherein manufacturing costs are reduced in comparison to other products known in the market, and the desired functionality, brightness, creaminess, softness, granularity, spreadability, among others, are exhibited by the product of the invention.

### DETAILED DESCRIPTION OF THE INVENTION

The composition of the invention as described herein is a water-in-oil composition, wherein the water oil ratio varies depending on the sought final product, whether margarine or spread, according to the common knowledge in the technical field of the invention. For example, for margarines, the fat component represents at least 80% w/w of the total content of the composition of the invention. Likewise, for spread, the fat component represents between the 10% and the 80% w/w of the total content of the composition of the invention.

In a preferred embodiment, the fat component of the invention comprises between 10% and 95% w/w of the total content of the composition. In a more preferred embodiment, the fat component of the invention comprises between 25% and 80% w/w of the total content of the composition. In an even more preferred embodiment, the fat component of the invention comprises between 55% and 80% w/w of the total content of the composition.

The fat phase of the composition of the invention comprises a fat component and a “post-crystallization control” component, wherein the fat component is at a range of 10% to 95% w/w of the total composition, and the “post-crystallization control” component is at a range of 0.1% to 5% w/w of the total composition. The “post-crystallization control” component content is chosen based on the fat content of the composition.

Particularly, the fat component of the composition of the invention contains at least one of palm oil and/or varieties and/or fractions thereof. The palm oil varieties include, without limitation, Guineensis, Oleifera, Guineensis x Oleifera, and any other palm oil variety known. The palm oil fractions may come from any of the palm varieties and include, without limitation, raw palm oil, refined, bleached, and deodorized (RBD) palm oil, palm stearin, palm olein, and any other palm oil fraction not included in this list.

The selection of the palm oil and/or varieties and/or fractions thereof is determined by its fatty acid and triglyceride content, so that, when combined a specific fatty acids and triglyceride profile is achieved.

Thus, the fat component of the composition of the invention comprises the following fatty acid content: palmitic acid at a range of 25% to 40% w/w of the total fat component, stearic acid at a range of 3% to 10% w/w of the total fat component, oleic acid at a range of 40% to 55% w/w of the total fat component, linoleic acid at a range of 7% to 15% w/w of the total fat component, lauric acid at less than 1% w/w of the total fat component, myristic acid at less than 1% w/w of the total fat component, and C4:0 to C24:0 fatty acids at up to 25% w/w of the total fat component.

In a particular embodiment of the invention, the fat component comprises the following fatty acid content: palmitic acid at a range of 29% to 38% w/w of the total fat component, stearic acid at a range of 3.5% to 8.5% w/w of the total fat component, oleic acid at a range of 40% to 52% w/w of the total fat component, linoleic acid at a range of 9% to 12% w/w of the total fat component, lauric acid at less than 1% w/w of the total fat component, myristic acid at less than 1% w/w of the total fat component, and C4:0 to C24:0 fatty acids at up to 20% w/w of the total fat component.

Simultaneously, the fat component of the composition of the invention comprises the following triglyceride content: a combination of POP and PPO at a range of 25% to 35% w/w of the total fat component, POO at a range of 20% to 35% w/w of the total fat component, PPP at a range of 3% to 10% w/w of the total fat component, 000 at a range of 4% to 10% w/w of the total fat component, and POS at a range of 2% to 6% w/w of the total fat component, wherein P is palmitic acid, O is oleic acid, and S is stearic acid.

In a particular embodiment of the invention, the fat component comprises the following triglyceride content: a combination of POP plus and PPO at a range of 25% to 31% w/w of the total fat component, POO at a range of 23% to 31% w/w of the total fat component, PPP at a range of 4% to 7% w/w of the total fat component, OOO at a range of 4% to 9% w/w of the total fat component, and POS at a range of 3% to 6% w/w of the total fat component, wherein P is palmitic acid, O is oleic acid, and S is stearic acid.

The fat component of the composition of the invention also comprises H2U triglycerides at a range of 30% to 45% w/w of the total fat component, HU2 triglycerides at a range of 30% to 50% w/w of the total fat component, U3 triglycerides at a range of 5% to 20% w/w of the total fat component, and H3 triglycerides at a range of 5% to 15% w/w of the total fat component, wherein H are hydrogenated fatty acids, and U are unsaturated fatty acids.

In a particular embodiment of the invention, the fat component comprises H2U triglycerides at a range of 35% to 44% w/w of the total fat component, HU2 triglycerides at a range of 38% to 44% w/w of the total fat component, U3 triglycerides at a range of 7% to 15% w/w of the total fat component, and H3 triglycerides at a range of 6% to 9% w/w of the total fat component, wherein H are hydrogenated fatty acids, and U are unsaturated fatty acids.

On the other hand, the “post-crystallization” component of the fat composition of the invention comprises a non-ionic surfactant and glycerol partial esters.

The non-ionic surfactant of the “post-crystallization” component is selected, without limitation, from sorbitan esters, sorbitan triestearate, or mixtures thereof.

The glycerol partial esters of the “post-crystallization” component are monoglycerides or diglycerides of saturated or unsaturated fatty acids, or mixtures thereof. In a particular embodiment of the invention, the saturated fatty acids of the glycerol partial esters are C16 or higher. In a more particular embodiment of the invention, the saturated fatty acids of the glycerol partial esters are C16 and/or C18. In a particular embodiment of the invention, the unsaturated fatty acids of the glycerol partial esters are C18:1 or higher both carbon atoms and unsaturations. In a more particular embodiment of the invention, the unsaturated fatty acids of the glycerol partial esters are C18:1 and/or C18:2.

Both the non-ionic surfactant and glycerol partial esters must have a HLB (Hydrophilic-Lipophilic Balance) of less than 6.

The ratio of the non-ionic surfactant and glycerol partial esters in the “post-crystallization” component is at least 1:0.5 and less than 1:10. In a preferred embodiment of the invention, the ratio of the non-ionic surfactant and glycerol partial esters is of at least 1:1.5 and less than 1:4. Said ratios are stablished for achieving a synergistic effect capable of preventing the formation of crystal granules in the composition after its crystallization.

The fat phase of the composition of the invention may further comprise at least one of the following components: emulsifiers, stabilizers, colorants, flavors, vitamins, or any other liposoluble component. The additional components of the fat phase are selected from those widely known and used in the technical field of the invention.

For example, the emulsifiers or stabilizers can be selected, without limitation, from the following: saturated and unsaturated monoglycerides and diglycerides, lecithin, polysorbates, propylene glycol esters, sorbitan esters, polyglycerol esters, lactylated esters, or ethoxylated esters. The emulsifiers or stabilizers, if present, are at a maximum of 5% w/w of the fat phase of the composition. The emulsifiers or stabilizers can improve the performance, physicochemical characteristics, and functionality of the composition of the invention.

Likewise, the flavorings are at a percentage between at between 0.002% to 0.3% w/w of the fat phase.

The aqueous phase of the composition of the invention is pure water, or water with at least one of the following components: salt, acidifying agent, preservatives, milk and derivatives thereof, gelling, or any other hydrosoluble component. The additional components of the aqueous phase are selected from those widely known and used in the technical field of the invention.

The aqueous phase represents between 5% to 90% w/w of the composition of the invention. In a preferred embodiment of the invention, the aqueous phase represents between 15% to 75% w/w of the composition. In a more preferred embodiment of the invention, the aqueous phase represents between 16% to 45% w/w of the composition.

The amount of the additional components of the aqueous phase is determined based on the total weight of the composition of the invention.

In one embodiment of the invention, the aqueous phase comprises a maximum of 2% w/w of the composition of salt. In a preferred embodiment, the aqueous phase comprises between 0.8% and 1% w/w of the composition of salt.

In one embodiment of the invention, the aqueous phase comprises a maximum of 1.5% w/w of the composition of milk powder. In a preferred embodiment, the aqueous phase comprises between 0.2% and 0.5% w/w of the composition of milk powder.

In one embodiment of the invention, the aqueous phase comprises an acidulant between 0.02% and 0.05% w/w of the composition. In a preferred embodiment, the aqueous phase comprises 0.04% w/w of the composition of acidulant.

In one embodiment of the invention, the aqueous phase comprises a sequestrant at a maximum of 0.008% w/w of the composition. In a preferred embodiment, the aqueous phase comprises the sequestrant at between 0.006% and 0.008% w/w of the composition.

In one embodiment of the invention, the aqueous phase comprises flavorings between 0.002% and 0.2% w/w of the composition.

General steps commonly known in the technical field of the invention are used for manufacturing the composition of the invention. Particularly, the process for obtaining the composition of the present invention comprises the following steps:
a) Mixing the non-ionic surfactant with the glycerol partial ester to obtain the “post-crystallization control” component.
b) Mixing the fat component with the “post-crystallization control” component to obtain the fat phase of the composition of the invention.
c) Heating the fat component to a temperature above its melting point, preferably, a temperature greater than 50° C.
d) Mixing the fat component with the aqueous phase at a temperature above its melting point, preferably, greater than 50° C.
e) Crystalize the water-fat mixture in order to obtain the water-in-oil emulsified composition of the invention.

In a particular embodiment of the process of the invention, emulsifiers/stabilizers, colorants, flavorings, vitamins among other fat-soluble ingredients, are added to the mixture obtained in step b.

The composition of the invention, which is obtained by the above-described process, exhibits a solid profile of N10 between 15% and 45%, N20 between 5% and 15%, N30 between 0% and 8%, and N40 lower than 2%, wherein the melting point of the composition of the invention is between 25° C. and 40° C.

In a particular embodiment of the invention, the composition of the invention exhibits a solid profile of N10 between 25% and 45%, N20 between 5% and 15%, N30 between 2% and 6%, and N40 lower than 1%.

Moreover, the composition of the invention has a penetration value lower than 300 g/cm² at 20° C. Preferably, the penetration value of the fat composition of the invention is lower than 200 g/cm² at 20° C.

Therefore, the composition of the invention exhibits suitable properties, such as softness and creaminess, for being used as a soft tub margarine or spread. Particularly, the composition of the invention does not comprise lumps, granules, or any other structural defect, that alter the texture or consistency of the product and are normally expected from compositions having palm oils.

Likewise, and considering the simplicity of the manufacturing process compared to other margarines or spreads known in the art, and also the use of palm oils as raw material, the composition of the invention provides a profitable alternative for the consumer.

### EXAMPLES

### Example 1: Components of a Soft Margarine Having 80% of Fat Content

As a preferred modality of the invention, a margarine composition according to the present invention has the following components:

### Fat Phase (80% w/w of the Composition)

Fat component (98.8% w/w of the fat phase): palm oil from the variety Guineensis x Oleifera
“Post-crystallization” component (0.5% w/w of the fat phase): Sorbitan ester as non-ionic surfactant, and monoglycerides and diglycerides of saturated fatty acids (Iodine value less than 3 g I₂/100 g) at a ratio of 1:1.6.
Additional components:
   Stabilizer (0.85% w/w of the fat phase): Grindsted® PS105KA
   Flavors at between 0.002% to 0.3% w/w of the fat phase

### Aqueous Phase (20% w/w of the Composition)

Salt: 0.9% w/w of the composition
Milk powder: 0.3% w/w of the composition
Acidulant: 0.04% w/w of the composition
Sequestrant: 0.0075% w/w of the composition
Flavorings: 0,002% to 0.2% w/w of the composition
Water: 18.6% w/w of the composition

### Example 2: Components of a Stick/Tub Spread Having 55% of Fat Content

As a preferred modality of the invention, a spread composition according to the present invention has the following components:

### Fat Phase (55% w/w of the Composition)

Fat component (98.85% w/w of the fat phase): palm oil from the variety Guineensis x Oleifera, palm olein fraction from the variety Guineensis, palm stearin fraction from Guineensis.
“Post-crystallization” component (0.3% w/w of the fat phase): Sorbitan triestearate as non-ionic surfactant, and monoglycerides and diglycerides of unsaturated fatty acids at a ratio of 1:3.3.
Additional components:
   Stabilizer/emulsifier (0.85% w/w of the fat phase): Grindsted® PS105KA and Polyglycerol Polyricinoleate 90
   Flavors at between 0.002% to 0.3% w/w of the fat phase

### Aqueous Phase (45% w/w of the Composition)

Salt: 0.9% w/w of the composition
Milk powder: 0.3% w/w of the composition
Acidulant: 0.04% w/w of the composition
Sequestrant: 0.0075% w/w of the composition
Flavorings: 0.002% to 0.2% w/w of the composition
Water: 43.6% w/w of the composition

### Example 3: Components of a Stick/Tub Spread Having 55% of Fat Content

As a preferred modality of the invention, a spread composition according to the present invention has the following components:

### Fat Phase (55% w/w of the Composition)

Fat component (98.85% w/w of the fat phase): palm oil fractions from the variety Guineensis
“Post-crystallization” component (0.3% w/w of the fat phase): Sorbitan triestearate as non-ionic surfactant, and monoglycerides and diglycerides of unsaturated fatty acids at a ratio of 1:3.3.
Additional components:
   Emulsifier (0.85% w/w of the fat phase): Palsgaard® 6151 and Polyglycerol Polyricinoleate 90
   Flavors at between 0.002% to 0.3% w/w of the fat phase

### Aqueous Phase (45% w/w of the Composition)

Salt: 0.9% w/w of the composition
Milk powder: 0.3% w/w of the composition
Acidulant: 0.04% w/w of the composition
Sequestrant: 0.0075% w/w of the composition
Flavorings: 0.002% to 0.2% w/w of the composition
Water: 43.6% w/w of the composition

### Example 4. Fat Profile of the Exemplary Compositions

The fatty acid profile of the fat component within the exemplified compositions is described below:

TABLE 1
Fatty acid profile of the exemplified compositions
(% w/w of the fat component)

| Fatty acid | Example 1 | Example 2 | Example 3 |
|---|---|---|---|
| C16:0 | 29.3 | 34.8 | 38.0 |
| C18:0 | 3.84 | 5.17 | 8.1 |
| C18:1 | 51.4 | 44.3 | 40.0 |
| C18:2 | 11.6 | 10.9 | 9.8 |

Likewise, the triglyceride composition of the fat component within exemplified compositions is described below:

TABLE 2
Triglyceride profile of the exemplified
compositions (% w/w of the fat component)

| Triglyceride | Example 1 | Example 2 | Example 3 |
|---|---|---|---|
| POP + PPO | 25.0 | 28.0 | 30.4 |
| POO | 30.4 | 26.8 | 23.1 |
| PPP | 4.4 | 5.6 | 6.9 |
| OOO | 8.9 | 6.5 | 4.0 |
| POS | 3.5 | 4.8 | 5.9 |
| H2U | 35.0 | 40.7 | 43.5 |
| HU2 | 43.2 | 39.7 | 36.2 |
| U3 | 13.2 | 9.6 | 7.1 |
| H3 | 6.4 | 7.4 | 8.6 |

The aqueous phase composition of the composition of the invention is described below:

TABLE 3
Component profile of the aqueous phase of the exemplified
compositions (% w/w of the composition)

| Component (%) | Example 1 | Example 2 | Example 3 |
|---|---|---|---|
| Salt | 0.9 | 0.9 | 0.9 |
| Acidulant | 0.04 | 0.04 | 0.04 |
| Sequestering | 0.0075 | 0.0075 | 0.0075 |
| Preservative | 0.09 | 0.09 | 0.09 |
| Powder milk | 0.3 | 0.3 | 0.3 |
| Water | 18.6 | 43.6 | 43.6 |

### Example 5. Characterization of the Exemplary Compositions

The solid profile of the exemplified composition is defined below:

TABLE 4
Solid profile and melting point of the exemplified compositions

| Solid profile | Example 1 | Example 2 | Example 3 |
|---|---|---|---|
| N10 | 26 | 36 | 42 |
| N20 | 6 | 9 | 14 |
| N30 | 2 | 3 | 6 |
| N40 | 0 | 0 | 1 |
| Melting point [° C.] | 28.75 | 37.65 | 39 |

Moreover, the functional and structural results of the exemplified compositions in comparison to a reference spread composition of palm oil are summarized below:

TABLE 5
Functional and structural features of
the exemplified compositions at 5 days

| | | | | Reference |
|---|---|---|---|---|
| | Example 1 | Example 2 | Example 3 | fat* |
| Penetrometry | 120 | 150 | 160 | 250 |
| 20° C. (g/cm²) | | | | |
| Spreadability | Spreadable | Spreadable | Spreadable | Slightly |
| | | | | spreadable |
| Brightness | Ok | Ok | Ok | No |
| | | | | brightness |
| Softness | Soft | Soft | Soft | Slightly |
| | | | | soft |
| Creaminess | Creamy | Creamy | Creamy | Not creamy |
| Granularity | Absent | Absent | Absent | Few lumps |
| Oil release | Absent | Absent | Absent | Absent |
| Grittiness | Absent | Absent | Absent | Absent |
| Separation | Absent | Absent | Absent | Absent |
| of phases | | | | |

*Standard Palm oil-based margarine

TABLE 6
Functional and structural features of
the exemplified compositions at 1 month

| | | | | Reference |
|---|---|---|---|---|
| | Example 1 | Example 2 | Example 3 | fat* |
| Penetrometry | 130 | 160 | 190 | 315 |
| 20° C. (g/cm²) | | | | |
| Spreadability | Spreadable | Spreadable | Spreadable | Not |
| | | | | spreadable |
| Brightness | Ok | Ok | Ok | No |
| | | | | brightness |
| Softness | Soft | Soft | Soft | Hard |
| Creaminess | Creamy | Creamy | Creamy | Not creamy |
| Granularity | Absent | Absent | Absent | Lumps |
| Oil release | Absent | Absent | Absent | Slight |
| | | | | separation |
| Grittiness | Absent | Absent | Absent | Slight |
| | | | | grittiness |
| Separation | Absent | Absent | Absent | Absent |
| of phases | | | | |

*Standard Palm oil-based margarine

TABLE 7
Functional and structural features of the
exemplified compositions at 3 months

| | | | | Reference |
|---|---|---|---|---|
| | Example 1 | Example 2 | Example 3 | fat* |
| Penetrometry | 140 | 190 | 210 | 450 |
| 20° C. (g/cm²) | | | | |
| Spreadability | Spreadable | Spreadable | Spreadable | Not |
| | | | | spreadable |
| Brightness | Ok | Ok | Ok | No |
| | | | | brightness |
| Softness | Soft | Soft | Soft | Hard |
| Creaminess | Creamy | Creamy | Creamy | Not creamy |
| Granularity | Absent | Absent | Absent | High |
| | | | | lumpiness |
| Oil release | Absent | Absent | Absent | Separation |
| Grittiness | Absent | Absent | Absent | Grittiness |
| Separation | Absent | Absent | Absent | Slight |
| of phases | | | | separation |

*Standard Palm oil-based margarine

TABLE 8
Functional and structural features of the
exemplified compositions at 6 months

| | | | | Reference |
|---|---|---|---|---|
| | Example 1 | Example 2 | Example 3 | fat* |
| Penetrometry | 200 | 250 | 240 | 730 |
| 20° C. (g/cm²) | | | | |
| Spreadability | Spreadable | Spreadable | Spreadable | Not |
| | | | | spreadable |
| Brightness | Ok | Ok | Ok | No |
| | | | | brightness |
| Softness | Soft | Soft | Soft | Hard |
| Creaminess | Creamy | Creamy | Creamy | Not creamy |
| Granularity | Absent | Absent | Absent | High |
| | | | | lumpiness |
| Oil release | Absent | Absent | Absent | Separation |
| Grittiness | Absent | Absent | Absent | Grittiness |
| Separation | Absent | Absent | Absent | Slight |
| of phases | | | | separation |

*Standard Palm oil-based margarine

After evaluating the functional and structural features of the exemplified compositions (Examples 1 to 3) at different times (5 days, 1 month, 3 months, and 6 months), it is noticed that said parameters are preserved during time.

Moreover, the creaminess, softness and spreadability are better than the ones of the reference fat. Likewise, there is absence of granularity, separation of phases, and grittiness, thus confirming that the compositions of the invention are more stable that the reference fat.

Furthermore, the penetration of the compositions of the invention is significatively lower than the penetration of the reference fat.

Accordingly, the compositions of the invention exhibit suitable characteristics for being used as soft tub margarines or spreads.

1. A fat composition comprising a fat phase and an aqueous phase, wherein the fat phase is between 10% and 95% w/w of the composition, the aqueous phase is between 5% and 90% w/w of the composition, and wherein the fat phase comprises a fat component of palm oil and/or fractions thereof and a post-crystallization control component.

2. The fat composition according to claim 1, wherein the post crystallization control component comprises a non-ionic surfactant and glycerol partial esters.

3. The fat composition according to claim 2, wherein the non-ionic surfactant is selected from sorbitan esters or sorbitan triestearate.

4. The fat composition according to claim 2, wherein the glycerol partial esters are monoglycerides or diglycerides of saturated or unsaturated fatty acids.

5. The fat composition according to claim 2, wherein the non-ionic surfactant and glycerol partial esters are at a ratio of between 1:0.5 to 1:10.

6. The fat composition according to claim 1, wherein the fat component comprises palmitic acid at a range of 25% to 40% w/w of the total fat component, stearic acid at a range of 3% to 10% w/w of the total fat component, oleic acid at a range of 40% to 55% w/w of the total fat component, linoleic acid at a range of 7% to 15% w/w of the total fat component, lauric acid at less than 1% w/w of the total fat component, myristic acid w/w of the total fat component, and C4:0 to C24:0 fatty acids at up to 10% w/w of the total fat component.

7. The fat composition according to claim 1, wherein the fat component comprises a combination of POP plus and PPO at a range of 25% to 35% w/w of the total fat component, POO at a range of 20% to 35% w/w of the total fat component, PPP at a range of 3% to 10% w/w of the total fat component, 000 at a range of 5% to 10% w/w of the total fat component, and POS at a range of 2% to 6% w/w of the total fat component, wherein P is palmitic acid, 0 is oleic acid, and S is stearic acid.

8. The fat composition according to claim 1, wherein the fat component comprises H2U triglycerides at a range of 30% to 45% w/w of the total fat component, HU2 triglycerides at a range of 30% to 50% w/w of the total fat component, U3 triglycerides at a range of 5% to 20% w/w of the total fat component, and H3 triglycerides at a range of 5% to 15% w/w of the total fat component, wherein H are hydrogenated fatty acids, and U are unsaturated fatty acids.

9. The fat composition according to claim 1, wherein the fat phase further comprises at least one of emulsifiers, stabilizers, colorants, flavors, vitamins, or any other liposoluble component.

10. The fat composition according to claim 9, wherein the emulsifier is at least one of saturated and unsaturated monoglycerides and diglycerides, lecithin, polysorbates, propylene glycol esters, sorbitan esters, polyglycerol esters, lactylated esters, or ethoxylated esters.

11. The fat composition according to claim 1, wherein the aqueous phase comprises at least one of salt, acidifying agent, preservatives, milk and derivatives thereof, gelling, or any other hydrosoluble component.

12. The fat composition according to claim 1 for use as soft margarine or spread.

13. A process for producing the fat composition according to claim 1, having the following steps:
a. Mixing a non-ionic surfactant with a glycerol partial ester to obtain a “post-crystallization control” component;
b. Mixing a fat component with the post-crystallization control component to obtain the fat phase of the composition;
c. Heating the fat component to a temperature above the melting point of said fat component;
d. Mixing the fat component with the aqueous phase to create a water-fat mixture; and
e. Crystalizing the water-fat mixture.
